(19) United States
(12) Patent Application Publication
(10) Pub. No.: US 2009/0122637 A1
(43) Pub. Date: May 14, 2009

(54) SINUSOIDAL MIXING AND SHEARING APPARATUS AND ASSOCIATED METHODS

(76) Inventor: Jan Kruyer, Thorsby (CA)

Correspondence Address: THORPE NORTH & WESTERN, LLP., P.O. Box 1219, SANDY, UT, 84091-1219, US

(21) Appl. No.: 11/939,978

(22) Filed: Nov. 14, 2007

(51) Int. Cl. B01F 13/00; B01F 15/00

(52) U.S. Cl. 366/167.1; 366/341

(57) ABSTRACT

An elongated conduit can be used for mixing and/or shearing a fluid. The elongated conduit can be configured as a repeating sinusoidal wave in a two-dimensional plane that is sufficient to restrict a line of sight down the length of the conduit. A method for mixing or shearing a fluid can include injecting the fluid at a high velocity into an end of a length of such a baffle-less conduit. Although a number of fluids can be effectively treated, disengagement of bitumen from the solids of oil sands ore and further treatment of bitumen products from other oil sands separation processes can be readily achieved.

### RELATED APPLICATIONS

This application is related to U.S. Patent Application No entitled “Hydrocyclone and Associated Methods,” filed concurrently herewith, which is incorporated herein by reference.

### FIELD OF THE INVENTION

The present invention relates to devices and methods for static mixing and/or shearing of fluids. Accordingly, the present invention involves the fields of materials science, chemistry, and chemical engineering.

### BACKGROUND OF THE INVENTION

According to some estimates, oil sands, also known as tar sands or bituminous sands, may represent up to two-thirds of the world's petroleum. Oil sands resources are relatively untapped. Perhaps the largest reason for this is the difficulty of extracting bitumen from the sands. Mineable oil sand is found as an ore in the Fort McMurray region of Alberta, Canada, and elsewhere. This oil sand includes sand grains having viscous bitumen trapped between the grains. The bitumen can be liberated from the sand grains by slurrying the as-mined oil sand in water so that the bitumen flecks move into the aqueous phase for separation. For the past 40 years, bitumen in McMurray oil sand has been commercially recovered using the original Clark Hot Water Extraction process, along with a number of improvements. Karl Clark invented the original process at the University of Alberta and at the Alberta Research Council around 1930 and improved it for over 30 years before it was commercialized.

In general terms, the conventional hot water process involves mining oil sands by bucket wheel excavators or by draglines at a remote mine site. The mined oil sands are then conveyed, via conveyor belts, to a centrally located bitumen extraction plant. In some cases, the conveyance can be as long as several kilometers. Once at the bitumen extraction plant, the conveyed oil sands are conditioned. The conditioning process includes placing the oil sands in a conditioning tumbler along with steam, water, and caustic soda in an effort to disengage bitumen from the sand grains of the mined oil sands. Further, conditioning is intended to remove oversize material for later disposal. Conditioning forms a hot, aerated slurry for subsequent separation. The slurry can be diluted for additional processing, using hot water. The diluted slurry is then pumped into a primary separation vessel (PSV). The diluted hot slurry is then separated by flotation in the PSV. Separation produces three components: an aerated bitumen froth which rises to the top of the PSV; primary tailings, including water, sand, silt, and some residual bitumen, which settles to the bottom of the PSV; and a middlings stream of water, suspended clay, and suspended bitumen. The bitumen froth can be skimmed off as the primary bitumen product. The middlings stream can be pumped from the middle of the PSV to sub-aeration flotation cells to recover additional aerated bitumen froth, known as a secondary bitumen product. The primary tailings from the PSV, along with secondary tailings product from flotation cells are pumped to a tailings pond, usually adjacent to the extraction plant, for impounding. The tailings sand can be used to build dykes around the pond and to allow silt, clay, and residual bitumen to settle for a decade or more, thus forming non-compacting sludge layers at the bottom of the pond. Clarified water eventually rises to the top for reuse in the process.

The bitumen froth is treated to remove air. The deaerated bitumen froth is then diluted with naptha and centrifuged to produce a bitumen product suitable for upgrading. Centrifuging also creates centrifugal tailings that contain solids, water, residual bitumen, and naptha, which can be disposed of in the tailings ponds.

More than 40 years of research and many millions of dollars have been devoted to developing and improving the Clark process by several commercial oil sands operators, and by the Alberta government. Research has largely been focused on improving the process and overcoming some of the major pitfalls associated with the Clark process. Some of the major pitfalls are:
1. Major bitumen losses from the conditioning tumbler, from the PSV and from the subaeration cells.
2. Reaction of hot caustic soda with mined oil sands result in the formation of naphthenic acid detergents, which are extremely toxic to marine and animal life, and require strict and costly isolation of the tailings ponds from the environment for at least many decades.
3. Huge energy losses due to the need to heat massive amounts of mined oil sands and massive amounts of water to achieve the required separation, which energy is then discarded to the ponds.
4. Loss of massive amounts of water taken from water sources, such as the Athabasca river, for the extraction process and permanently impounded into the tailings ponds that can not be returned to the water sources on account of its toxicity. For example, to produce one barrel of oil requires over 2 barrels of water from the Athabasca river.
5. The cost of constructing and maintaining a large separation plant.
6. The cost of transporting mined oil sands from a remote mining location to a large central extraction plant by means of conveyors. Additionally, the conveyors can be problematic.
7. The cost of dilution centrifuging.
8. The cost of naphtha recovery.
9. The cost of maintaining and isolating huge tailings ponds.
10. The cost of preventing leakage of toxic liquids from the tailings ponds.
11. The cost of government fines when environmental laws are breached.
12. The eventual cost of remediation of mined out oil sands leases and returning these to the environment in a manner acceptable to both the Alberta and the Canadian government.
13. The environmental impact of the tailings ponds.

Some major improvements have been made that included lowering the separation temperature in the tumbler, the PSV, and the flotation cells. This reduced the energy costs to a degree but also required the use of larger tumblers and the addition of more air to enhance bitumen flotation. Another improvement eliminated the use of bucket wheel excavators, draglines and conveyor belts to replace these with large shovels and huge earth moving trucks, and then later to replace some of these trucks with a slurry pipeline to reduce the cost of transporting the ore from the mine site to the separation plant. Slurry pipelines eliminate the need for conditioning tumblers but require the use of oil sand crushers to prevent pipe blockage and require cyclo-feeders to aerate the oil sand slurry as it enters the slurry pipeline, and may also require costly compressed air injection into the pipeline. Other improvements included tailings oil recovery units to scavenge additional bitumen from the tailings, and naptha recovery units for processing the centrifugal tailings before these enter the tailings ponds.

More recent research is concentrating on reducing the separation temperature of the Clark process even further and on adding gypsum or flocculants to the sludge of the tailings ponds to compact the fines and release additional water. However, adding gypsum hardens the water and this can require softening of the water before it can be recycled to the extraction plant. Most of these improvements have served to increase the amount of bitumen recovered and reduce the amount of energy required, but have increased the complexity and size of the commercial oil sands plants.

One particular problem that has vexed commercial mined oil sands plants is the problem of fine tailings disposal. In the current commercial process, mined oil sands are mixed and stirred with hot water, air, and caustic soda to form a slurry that is subsequently diluted with cooler water and separated in large separation vessels. In these vessels, air bubbles attach to bitumen droplets of the diluted slurry and cause bitumen product to float to the top for removal as froth. Caustic soda serves to disperse the fines to reduce the viscosity of the diluted slurry and allows the aerated bitumen droplets to travel to the top of the separation vessels fast enough to achieve satisfactory bitumen recovery in a reasonable amount of time. Caustic soda serves to increase the pH of the slurry and thereby imparts electric charges to the fines, especially to the clay particles, to repel and disperse these particles and thereby reduce the viscosity of the diluted slurry. For most oil sands without caustic soda, the diluted slurry would be too viscous for effective bitumen recovery. It can be shown from theory or in the laboratory that for an average oil sand, it takes five to ten times as long to recover the same amount of bitumen if no caustic soda is added to the slurry. Such a long residence time would make commercial oil sands extraction much more expensive and impractical.

While caustic soda is beneficial as a viscosity breaker in the separation vessels for floating off bitumen, it is environmentally very detrimental. At the high water temperatures used during slurry production it reacts with naphthenic acids in the oil sands to produce detergents that are highly toxic. Not only are the tailings toxic, but also the tailings fines will not generally settle. Tailings ponds with a circumference as large as 20 kilometers are required at each large mined oil sands plant to contain the fine tailings. Coarse sand tailings are used to build huge and complex dyke structures around these ponds.

Due to the prior addition of caustic soda, the surfaces of the fine tailings particles are electrically charged, which in the ponds, causes the formation of very thick layers of microscopic card house structures that compact extremely slowly and take decades or centuries to dewater. Many millions of dollars per year have been and are being spent in an effort to maintain the tailings ponds and to find effective ways to dewater these tailings. Improved mined oil sands processes must be commercialized to overcome the environmental problems of the current plants. One such alternate method of oil sands extraction is the Kruyer Oleophilic Sieve process invented in 1975.

Like the Clark Hot Water process, the Kruyer Oleophilic Sieve process originated at the Alberta Research Council and a number of Canadian and U.S. patents were granted to Kruyer as he privately developed the process for over 30 years. The first Canadian patent of the Kruyer process was assigned to the Alberta Research Council and, and all subsequent patents remain the property of Kruyer. Unlike the Clark process, which relies on flotation of bitumen froth, the Kruyer process uses a revolving apertured oleophilic wall (trade marked as the Oleophilic Sieve) and passes the oil sand slurry to the wall to allow hydrophilic solids and water to pass through the wall apertures whilst capturing bitumen and associated oleophilic solids by adherence to the surfaces of the revolving oleophilic wall.

Along the revolving apertured oleophilic wall, there are one or more separation zones to remove hydrophilic solids and water and one or more recovery zones where the recovered bitumen and oleophilic solids are removed from the wall. This product is not an aerated froth but a viscous liquid bitumen.

A bitumen-agglomerating step normally is required to increase the bitumen particle size before the slurry passes to the apertured oleophilic wall for separation. Attention is drawn to the fact that in the Hot Water Extraction process the term “conditioning” is used to describe a process wherein oil sands are gently mixed with controlled amounts water in such a manner as to entrain air in the slurry to eventually create a bitumen froth product from the separation. The Oleophilic Sieve process also produces a slurry when processing mined oil sands but does not “condition” it. Air is not required, nor desired, in the Oleophilic Sieve process. As a result, the slurry produced for the Oleophilic Sieve, as well as the separation products, are different from those associated with the conventional Hot Water Extraction process. The Kruyer process was tested extensively and successfully implemented in a pilot plant with high grade mined oil sands (12 wt % bitumen), medium grade mined oil sands (10 wt % bitumen), low grade oil sands (6 wt % bitumen) and with sludge from commercial oil sands tailings ponds (down to 2% wt % bitumen), the latter at separation temperatures as low as 5° C. A large number of patents are on file for the Kruyer process in the Canadian and U.S. Patent Offices. These patents include: CA 2,033,742; CA 2,033,217; CA 1,334,584; CA 1,331,359; CA 1,144,498 and related U.S. Pat. No. 4,405,446; CA 1,141,319; CA 1,141,318; CA 1,132,473 and related U.S. Pat. No. 4,224,138; CA 1,288,058; CA 1,280,075; CA 1,269,064; CA 1,243,984 and related U.S. Pat. No. 4,511,461; CA 1,241,297; CA 1,167,792 and related U.S. Pat. No. 4,406,793; CA 1,162,899; CA 1,129,363 and related U.S. Pat. No. 4,236,995; and CA 1,085,760.

While in a pilot plant, the Kruyer process has yielded higher bitumen recoveries, used lower separation temperatures, was more energy efficient, required less water, did not produce toxic tailings, used smaller equipment, and was more movable than the Clark process. There were a number of drawbacks, though, to the Kruyer process.

One drawback to the Kruyer process is related to the art of scaling up. Scaling up a process from the pilot plant stage to a full size commercial plant normally uncovers certain engineering deficiencies of scale such as those identified below.

Commercial size apertured drums that may be used as revolving apertured oleophlilic walls require very thick perforated steel walls to maintain structural integrity. Such thick walls increase retention of solids by the bitumen and may degrade the resulting bitumen product. Alternately, apertured mesh belts may be used as revolving apertured oleophilic walls. These have worked well in the pilot plant but after much use, have tended to unravel and fall apart. This problem will likely be exacerbated in a commercial plant running day and night. Rugged industrial conveyor belts are available. These are made from pre-punched serpentine strips of flat metal and then joined into a multitude of hinges by cross rods to form a rugged industrial conveyor belt. Other industrial metal conveyor belts are made from flattened coils of wire and then joined into a multitude of hinges by cross rods to form the belts. Both types of metal belts were tested and have stood up well in a pilot plant. However, it was difficult and energy intensive to remove most of the bitumen product in the recovery zone from the surfaces of the belts before these revolved back to the separation zone.

Bitumen agglomerating drums using oleophilic free bodies, in the form of heavy oleophilic balls that tumbled inside these drums worked very well in the pilot plant. However commercial size agglomerators using tumbling free bodies may require much energy and massive drum structures to contain a revolving bed of freely moving heavy oleophilic balls with adhering viscous cold bitumen to achieve the desired agglomeration of dispersed bitumen particles.

As such, improvements to methods and related equipment for recovery of bitumen from oil sands continue to be sought through ongoing research and development efforts.

### SUMMARY OF THE INVENTION

Accordingly, the present invention relates to the separation of mined oil sands or bitumen containing mixtures by an endless oleophilic belt formed by wrapping an oleophilic endless wire rope a plurality of times around two or more drums or rollers to form a multitude of sequential oleophilic wraps wherein hydrophilic materials including water and hydrophilic solids pass through the spaces or voids between said sequential wraps in a separation zone and oleophilic materials including bitumen and oleophilic solids are captured by the oleophilic wraps for subsequent removal in a recovery zone. Before mined oil sands can be separated, bitumen can be disengaged from the sand grains by a mixing and/or shearing action in the presence of a continuous water phase.

The present invention relates particularly to a mixing and/or shearing apparatus. The apparatus includes an elongated pipe. The pipe is configured as a repeating sinusoidal wave in a two-dimensional plane. Further, the sinusoidal wave is configured to restrict a line of sight down the length of the pipe. In various embodiments, the pipe can include various elbow pipe sections and/or straight pipe sections to form a variety of tortuous and non-linear flow paths.

Likewise, a method for mixing and/or shearing a fluid can include injecting the fluid at a high velocity into an end of a length of a baffleless pipe configured as a repeating sinusoidal wave. In one embodiment, the velocity component of the fluid repeatedly alters positive and negative directions.

Such apparatus and method can be used for a variety of applications, and specifically for mixing or shearing an oil sands and water fluid mixture. In a further embodiment, the mixing and/or shearing the water and oil sands fluid mixture can cause removal or disengagement of bitumen from sand grains of the oil sand. In other embodiments, such apparatus and method may be used to mix water with bitumen froth from froth flotation. Such mixing serves to disperse the bitumen froth, remove air and transfer hydrophilic particulates from the dispersing bitumen to the continuous water phase. In a further embodiment, the dispersed bitumen can be injected or otherwise allowed to travel down a length of pipe configured as a repeating sinusoidal wave where sinusoidal bends are more moderate to allow bitumen to agglomerate. Such treatment allows the bitumen to agglomerate with the addition of emulsion breaking chemicals. Alternatively, a drum-type agglomerator can be used to further separate out bitumen from the continuous water phase. Similarly, bitumen product from an oleophilic apertured wall may be dispersed with water in the apparatus of the instant invention to transfer hydrophilic particulates from the bitumen phase to the aqueous phase without the need for air removal, followed by bitumen agglomeration and separation.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1 is a side view of an elongated pipe according to one embodiment of the present invention. The dotted line represents an idealized flow path of solids and/or fluid within a fluid consistent with one embodiment of the present invention.

FIG. 2 is a side view of an elongated pipe according to another embodiment of the present invention having more moderate bends down the length of the pipe.

FIG. 3 is a side view of an elongated pipe according to yet another embodiment of the present invention having steep bends down the length of the pipe.

FIG. 4 is a cross-sectional view of the elongated pipe of either FIG. 1, 2 or 3, showing fluid flow patterns and solids accumulation, according to one embodiment of the present invention.

It will be understood that the above figures are merely for illustrative purposes in furthering an understanding of the invention. Further, the figures are not drawn to scale, thus dimensions, particle sizes, and other aspects may, and generally are, exaggerated or changed to make illustrations thereof clearer. Therefore, departure can be made from the specific dimensions and aspects shown in the figures in order to produce the elongated pipes of the present invention.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “a pump” includes one or more of such pumps, reference to “an elbow” includes reference to one or more of such elbows, and reference to “the particle” includes reference to one or more of such particles.

Definitions

In describing and claiming the present invention, the following terminology will be used in accordance with the definitions set forth below.

As used herein, “agglomeration drum” refers to a revolving drum containing oleophilic surfaces that is used to increase the particle size of bitumen in oil sand slurries prior to separation. Bitumen particles flowing through the drum come in contact with the oleophilic surfaces and adhere thereto to form a layer of bitumen of increasing thickness until the layer becomes so large that shear from the flowing slurry and from the revolution of the drum causes a portion of the bitumen layer to slough off, resulting in bitumen particles that are much larger than the original bitumen particles of the slurry.

As used herein, “bitumen” refers to a viscous hydrocarbon, including maltenes and asphaltenes, that is found in oil sands ore interstitially between the sand grains. In a typical oil sands plant, there are many different streams that may contain bitumen.

As used herein, “central location” refers to a location that is not at the periphery, introductory, or exit areas. In the case of a pipe, a central location is a location that is neither at the beginning of the pipe nor the end point of the pipe and is sufficiently remote from either end to achieve a desired effect, e.g. washing, disruption of agglomerated materials, etc.

As used herein, “conditioning” in reference to mined oil sand is consistent with conventional usage and refers to mixing a mined oil sand with water, air and caustic soda to produce a warm or hot slurry of oversize material, coarse sand, silt, clay and aerated bitumen suitable for recovering bitumen froth from said slurry by means of froth flotation. Such mixing can be done in a conditioning drum or tumbler or, alternatively the mixing can be done as it enters into a slurry pipeline and/or while in transport in the slurry pipeline. Conditioning aerates the bitumen for subsequent recovery in separation vessels, e.g. by flotation.

As used herein, “conduit” refers to any enclosed path used for transporting a fluid such as pipe, tube or hose and may be made from metal, rubber or plastic and may generally have a circular cross-section, although any suitable cross-section may be used.

As used herein, “disengagement” and “digesting” of bitumen are used interchangeably, and refer to a primarily physical separation of bitumen from sand or other particulates in mined oil sand slurry. Disengagement of bitumen from oil sands occurs when physical forces acting on the oil sand slurry results in the at least partial segregation of bitumen from sand particles in an aqueous medium. Such disengagement is intended to be an alternative approach to conventional conditioning, although disengagement could optionally be performed in conjunction with conditioning.

As used herein, “endless cable belt” when used in reference to separations processing refers to an endless cable that is wrapped around two or more drums and/or rollers a multitude of times to form an endless belt having spaced cables. Movement of the endless cable belt can be facilitated by at least two guide rollers or guides that prevent the cable from rolling off an edge of the drum or roller and guide the cable back onto the drum or roller. The spaces in the endless belt are the slits or gaps between sequential wraps. The endless cable can be a wire rope, a plastic rope, a metal cable, a single wire, compound filament (e.g. sea-island) or a monofilament which is spliced together to form a continuous loop, e.g. by splicing. As a general guideline, the diameter of the endless cable can be as large as 2 cm and as small as 0.001 cm, although other sizes might be suitable for some applications. An oleophilic endless cable belt is an endless cable belt made from a material that is oleophilic under the conditions at which it operates.

As used herein, “fluid” refers to flowable matter. Fluids, as used in the present invention typically include a liquid or gas, and may optionally further include amounts of solids and/or gases dispersed therein. As such, fluid specifically includes slurries (liquid with solid particulate), aerated liquids, and combinations of the two fluids. In describing certain embodiments, the term slurry and fluid may be interchangeable, unless explicitly stated to the contrary.

As used herein, “pipe” or “pipes” refers to conduit that is capable of containing and guiding a flowing fluid and having a substantially circular cross-section. This can be conventional commercial pipe but also may refer to tube and/or hose.

As used herein, the term “metallic” refers to both metals and metalloids. Metals include those compounds typically considered metals found within the transition metals, alkali and alkali earth metals. Non-limiting examples of metals are Ag, Au, Cu, Al, and Fe. In one aspect, suitable metals can be main group and transition metals. Metalloids include specifically Si, B, Ge, Sb, As, and Te, among others. Metallic materials also include alloys or mixtures that include metallic materials. Such alloys or mixtures may further include additional additives.

As used herein, “operatively associated with” refers to any functional association which allows the identified components to function consistent their intended purpose. For example, units such as pumps, pipes, vessels, tanks, etc. can be operatively associated by direct connection to one another or via an intermediate connection such as a pipe or other member. Typically, in the context of the present invention, the units or other members can be operatively associated by fluid communication amongst two or more units or devices.

As used herein, “repeating sinusoidal wave in a two-dimensional plane” refers to a shape that, when viewed from a projected side view, has the characteristics of a repeating harmonic wave, i.e. a sinusoidal wave. As such, the sinusoidal wave may in some cases be defined or described in terms associated with sine waves. A repeating sinusoidal wave, according to the present invention, has amplitude and periods. The sinusoidal wave can be deformed, can have delays in period, can be dampened in all or some of the length of the wave. A pipe in the shape of the wave is not necessarily in a two-dimensional plane of motion. In a specific embodiment, the sinusoidal pipe is substantially two-dimensional and can be described as serpentine. Alternatively, the sinusoidal pipe can have three-dimensional aspects such that at least a portion of the path is out of plane. However, the sinusoidal wave of the present invention is distinct from helical or spiral shapes in that that repeating sinusoidal wave has a velocity directional vector that alternates, whereas spiral and helical shapes are subject to velocity directional vectors that are rotational-based and relatively constant about an axis of rotation. Specifically, repeating sinusoidal waves according to the present invention do not have identifiable axes of rotation parallel to the length of the pipe for longer than one period of repetition of the sine wave shape. At times, and for ease of discussion, the term “repeating sinusoidal wave in a two-dimensional plane” may be shortened to “sinusoidal wave.”

As used herein, “periodically crosses” refers to a regular crossing or traversing of particles at periodic intervals (i.e. regular or irregular, but repeating) across the bulk flow of a flowing fluid.

As used herein, “velocity” is used consistent with a physics-based definition; specifically, velocity is speed having a particular direction. As such, the magnitude of velocity is speed. Velocity further includes a direction. When the velocity component is said to alter, that indicates that the bulk directional vector of velocity acting on an object in the fluid stream (liquid particle, solid particle, etc.) is not constant. Spiraling or helical flow-patterns are specifically defined to have substantially constant or gradually changing bulk directional velocity.

As used herein, the term “substantially” refers to the complete or nearly complete extent or degree of an action, characteristic, property, state, structure, item, or result. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, a plurality of components may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, particle sizes, volumes, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 centimeter to about 5 centimeters” should be interpreted to include not only the explicitly recited values of about 1 centimeter to about 5 centimeters, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described. In addition, consistent with this provision, the term “about” explicitly includes “exactly” unless clearly indicated otherwise.

### Embodiments of the Invention

It has been found that fluids, particularly those including oil sand and water, can be mixed and/or sheared by using a sinusoidal-shaped elongated conduit. Such sinusoidal conduits can be used generically as static mixers for a variety of fluids. With oil sands, the sinusoidal conduit can be used to prepare and/or condition an oil sand slurry with warm water and caustic soda, to produce a conditioned slurry similar to those used in present hot water processes. In another specific embodiment, a sinusoidal conduit can be used to digest mined oil sand in relatively little time and without the need for caustic soda and in some cases without injected steam or air. Further, in another embodiment, the digesting of mined oil sand can be performed at warm or moderate temperatures, e.g. 20° C. to about 60° C. A sinusoidal conduit can allow for a great deal of versatility in manufacturing. Such conduits can be used, in addition to mixing or shearing, to transport fluid from one point to another. Sinusoidal conduits can be used above ground with mined oil sands and can allow for placing the extraction plant close to the mine site. Alternatively, the sinusoidal conduit can be placed underground for oil sand deposits where the overburden has not been removed.

In situations where the overburden has not been removed, the oil sand deposits are typically so far below the surface that overburden removal would be prohibitively expensive. These deposits normally are not frozen which facilitates processing since frozen lumps of oil sand would not move as readily in an aqueous medium through the pipes and digest as quickly as unfrozen lumps. Being below the surface can imply that there is little room for a long sinusoidal conduit. In this case, the conduit can loop back on itself several times to achieve proper digestion of the oil sand. This would be necessary in the limited space typically available underground if the oil sand is to be separated below the surface. On the other hand, if the oil sand is mined below the overburden but separation is to take place at the surface, then the serpentine conduit may be mounted in a vertical or sloping position to pump and digest the oil sand between the underground mining operation and the above ground extraction plant.

In another situation, the overburden may be removed from the oil sand but the mine site may be remote from the extraction plant. In such a case, the elongated pipe can be in line and would not loop back on itself. The pipe may be attached to a conventional non-serpentine or straight pipeline at the front or at the rear to digest the oil sand and transport it from the mine site to the extraction plant. In this case, the pipeline or the sinusoidal conduit may carry frozen lumps of oil sand in water during winter time. In still another situation, the overburden may be removed and the extraction plant may be close to the mine site. This situation can be treated the same as if the mine site were remote, however as there is no need to transport the oil sand and water mixture over a long distance, the sinusoidal pipe may be made to loop back upon itself one or a plurality of times, depending on plant layout.

In accordance with the above discussion, various embodiments and variations are provided herein which are applicable to each of the apparatus, fluid flow patterns, and method of mixing and/or shearing a fluid. Thus, discussion of one specific embodiment is related to and provides support for this discussion in the context of the other related embodiments.

As noted, an apparatus for mixing, shearing or mixing and shearing a fluid can include an elongated conduit configured as a repeating sinusoidal wave in a two-dimensional plane sufficient to restrict a line of sight down the length of the conduit. Restricting line of sight down the length of conduit ensures that fluids traveling through the conduit are mixed and/or sheared to a degree and in a manner that is desirable and can achieve the stated disengagement of bitumen from sand in an aqueous medium.

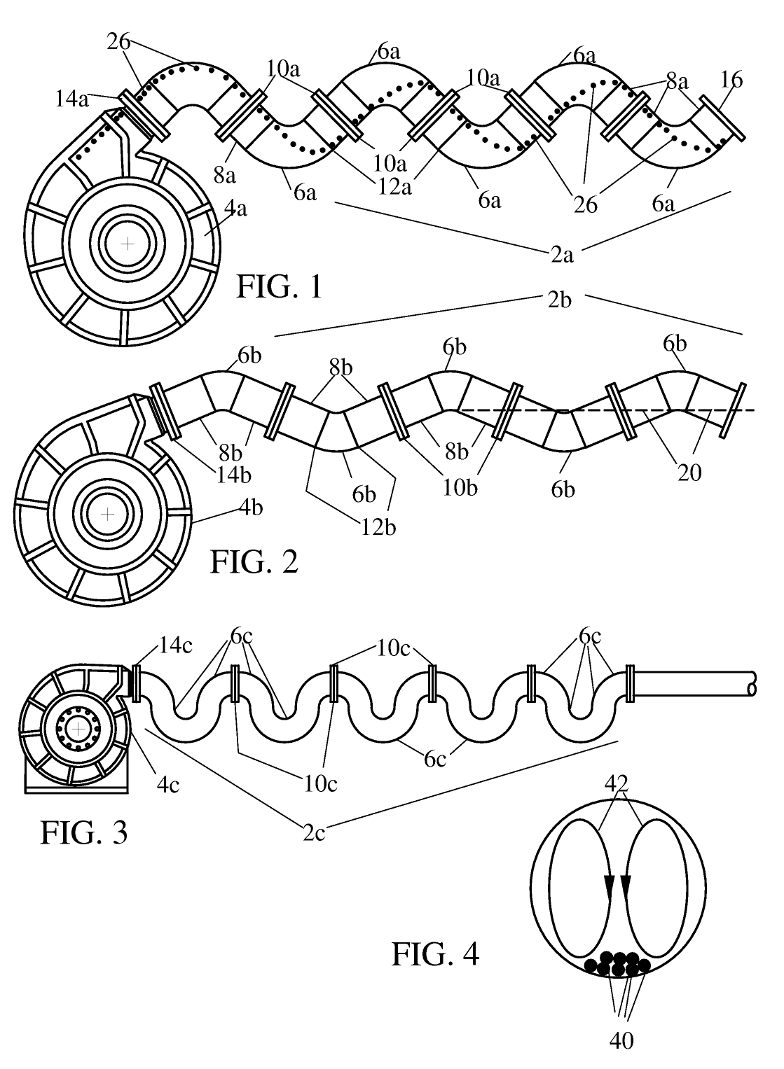

One embodiment of the elongated conduit is shown in FIG. 1. The figure illustrates an elongated pipe 2a attached at an initial end to a pump 4a. This embodiment includes a plurality of pipe sections attached together to form the elongated pipe by sequentially alternating elbow section 6a and flanged straight pipe sections 8a connected in series. This particular embodiment illustrates a variety of joints including flanged joints 10a in between straight pipe sections and non-flanged joints 12a connecting elbows to straight pipe sections. Typically, such elbows are commercially available including flanged ends, although any suitable coupling mechanism can be used. The pump can be connected directly to the pipe with a flanged joint 14a. Additional piping and fittings may be necessary before the pump can deliver a fluid to the serpentine pipe depending on the location of the pump and other process equipment.

In embodiments that incorporate a plurality of pipe sections, including elbows, the elbows can be of any angle that allows for the elongated pipe to be in a repeating sinusoidal wave in a two-dimensional plane. It can be useful, depending on the type and size of pipe, to incorporate readily-available pipe elbows. In one embodiment, at least one elbow can be selected from 22.5 degree, 30 degree, 45 degree or 90 degree elbow. Typically, an elbow having a bend angle between 22 and 91 degrees can provide the desired affects, depending on the other factors discussed herein. In one design, more than one elbow can be used together to form a bend, which can function as a single bend, however may be closer to a curved arc than a bent angle. In embodiments that include a plurality of elbows, the elbows can be substantially the same angle, or can include a plurality of different angles. In a detailed embodiment, such as in FIG. 1, the elbows can each have a substantially identical bend angle which alternate directions. The degree of bending can be chosen based on the particular slurry and conditions.

FIG. 2 shows an elongated pipe 2b in accordance with another embodiment of the present invention and configured as a repeating sinusoidal wave in a two-dimensional plane sufficient to restrict a line of sight 20 down the length of the pipe. As with FIG. 1, FIG. 2 has a pump 4b attached at an inlet 14b of the pipe. The pipe includes a plurality of elbows 6b and flanged substantially straight pipe sections 8b. Also similar to the pipe of FIG. 1, the pipe of FIG. 2 includes both flanged joints 10b and non-flanged joints 12b. FIG. 2 does differ from FIG. 1, however, in that the elbows are shallower angles than the elbows of FIG. 1. Even with the shallower angles of the elbows in FIG. 2, the repeating sinusoidal wave in a two-dimensional plane is sufficient to restrict a line of sight, indicated by dashed line 20, down the length of the pipe. Such shallower angles can be useful when bitumen is not as tightly associated with the sand particles, e.g. under higher temperature operations, specific tar sand types, etc.

Rather than including a plurality of straight pipe sections placed between elbow joints, in one embodiment, the elongated pipe can be a plurality of connected U-shaped elbows 6c as shown in FIG. 3. In this embodiment, the sinusoidal pipe 2c includes a plurality of elbows 6c connected directly together. The elbows are segments having inlet and outlet ends which are in-line with the overall length of the pipe with a central portion of each segment being bent as shown to form a splayed C shape. The elbows are connected by flanged joints 10c. As with the previous embodiments, a pump 4c is attached directly to the sinusoidal pipe by a flanged joint 14c at the inlet of the sinusoidal pipe.

In another embodiment, the sinusoidal pipe can be formed without elbows. For example, a single length of pipe or tube can be created or formed to the desired sinusoidal shape by conventional pipe or tube bending equipment or other suitable shaping techniques. This embodiment can be relatively inexpensive to make and install, but may also reduce access to internal pipe sections for cleaning and/or maintenance. Alternatively, shorter sections of pipe can be bent and connected together to form the overall desired sinusoidal shape and to facilitate access.

In yet another embodiment, the desired sinusoidal-shaped elongated pipe can be a rubber, urethane or plastic hose that is molded, formed or forced into a sinusoidal shape to provide the desired mixing and/or shearing of a fluid. Normally such a hose would contain steel or other reinforcing materials inside the hose wall to generally maintain a round or smooth oval cross section of the hose.

As mentioned, a sinusoidal wave in a two-dimensional plane does not necessarily indicate that the pipe, tube or hose is confined solely to a two-dimensional serpentine shape. Rather, it indicates that, when viewed in a two-dimensional plane, i.e. projected onto a flat surface, the pipe, tube or hose appears as a repeating sinusoidal wave. In a specific embodiment, the conduit in the shape of a repeating sinusoidal wave can be substantially two-dimensional. In a specific embodiment, the conduit can include a plurality of elbows forming alternating joints. Such is the case with FIG. 1 and FIG. 2. In an alternate embodiment, the conduit can be three-dimensional in shape such that at least a portion of the conduit is out of plane, but project a repeating sinusoidal wave in a two-dimensional plane. For example, every other elbow of any of the illustrated figures could be rotated from about 5° to 90° out of plane. In this case, the side view would be somewhat similar to those illustrated while a top view would be non-linear.

When used, the substantially straight conduit sections can be of any length that allows for the repeating sinusoidal wave in a two-dimensional plane, and is sufficient to restrict a line of sight down the length of the conduit. Clearly, this length can be dependent on a variety of factors, including the angles of bend in the elongated pipe, e.g. elbows, number of bends, and the width of the open channel of pipe. That said, in one embodiment, the substantially straight pipe sections can have an average length of about 20 to about 200 centimeters.

One benefit of using a plurality of conduit sections to construct the elongated conduit is that repair and replacement is relatively easy. For example, if a segment of the elongated conduit needs replacing, it is a much simpler process to remove and replace the individual conduit section than to replace the entire elongated conduit. Furthermore, as some maintenance of the elongated conduit may require access to the inner channel of the conduit, it is generally simpler to detach or remove a conduit section and thus have access to the inner area of the conduit, rather than insert tools and equipment down the length of the conduit, or to cut into a single conduit. In embodiments that include a plurality of conduit sections, the sections can be attached in any fashion that maintains that connection during normal use for the desired use time. In a specific embodiment, at least one of the attachments can be attachment by a flanged joint. FIG. 1, FIG. 2 and FIG. 3 each show flanged joints 10. Spacing flanged joints, as opposed to welded joints, periodically along the length of the sinusoidal conduit allows for ease of repair of the sections. Additionally, using flanged joints can allow for repair, maintenance, or treating the inner surface of the elongated conduit. Further, relatively short flanged sections can be preferred in some embodiments, as they allow for easier repairs and/or maintenance as opposed to larger sections attached by flanged joints.

One benefit of flanged joints, although not required, is in treating the inner surface of the conduit. Some fluids can include particulate solids, and often abrasive particulate, which can wear or otherwise alter at least part of the inner surface of the conduit. Some fluids can affect the inner surface of the conduit in other ways, such as corrosion and/or erosion. As such, it can be useful to provide additional wearing surfaces, particularly in the case of particulate solids in the fluid, and to reinforce such wearing surfaces to extend the working life of the surface, and thus the conduit. Wearing surfaces can include, but are not limited to, alloy hard surfacing, ceramic coating, or the like. Flanges are not required for the instant invention but can be preferred in some embodiments, since short flanged sections allow repair of each section after it has been abraded for a while by coarse solids flowing through the serpentine conduit. The use of flanges also makes it more convenient to hard plate, e.g. chrome plate, the inside of these sections individually to make it more wear resistant, or to hard surface the inside of a plurality or of each section in those areas where the inside surface is impacted by colliding solids. Hard surfacing may be done by bead welding, overlay welding, boriding, ceramic deposition, build up, cladding, electrodeposition, or by other suitable means. Such surfacing can be uniform or patterned, e.g. herringbone, dot, bead strings, waffle, etc. Abrasion resistance may also be provided by lining at least the wearing surface of the inside of the serpentine conduit sections with a substance such as plastic, rubber, urethane or epoxy.

Analysis of fluid flow, taking into consideration the composition of the fluid and the conduit, can indicate the potential wearing surfaces which will experience the most wear. For processing fluids with particulate solids, the wearing surfaces may include the surfaces of the conduit where the particulate solids congregate for greater periods of time along the path of the conduit. For example, at bends in the contours of the elongated conduit, particulate solids tend to impact or concentrate. These areas are more likely to experience abrasive erosion than more straight sections or even the inside walls just past a curve or elbow on the inner curve side. In the cases of corrosive and/or erosive materials, the wearing surface may include a majority of the inner surface of the conduit. As such, in one embodiment, at least a portion of an inner surface of the elongated conduit can be reinforced as a wearing surface. In a further embodiment, a majority of the inner surface of the elongated conduit can be reinforced as a wearing surface.

In one embodiment, plating material onto the surface can reinforce the inner surface of an elongated conduit or make it more wear resistant. The plated material preferably has a greater hardness than the conduit surface, or is more resistant, chemical or otherwise, to fluid action on the surface than the untreated conduit inner surface. One of the materials used to plate the inner surface of a conduit can comprise or consist essentially of chrome or of metal carbides, such as titanium carbide or tungsten carbide. Another manner of reinforcing a wearing surface can include hard surfacing the inner surface with welding tracks or beads. Other methods of reinforcing a wearing surface can include surface treatments, such as forming one or more films on the surface, and roughing or smoothing the surface. In a specific embodiment, at least a portion of an inner surface of the elongated conduit includes an anti-corrosive material including chrome, nickel, rubber, urethane, polymer or epoxy coating.

The conduit, as described using mathematical terminology related to sinusoidal harmonic waves can be further described as optionally having delays in period, greater amplitude than period, greater period than amplitude, varying slopes, etc. In a specific embodiment, the repeating sinusoidal wave of the elongated conduit can have an amplitude and a period such that a ratio of the amplitude to the period is from about 1:5 to about 5:1. In a specific embodiment, the ratio of the amplitude to the period can be about 1:2 to about 2:1. The sinusoidal wave can repeat any number of times as determined by the desired processing, type and size of conduit, and fluid to be processed. In a specific embodiment, the repeating sinusoidal wave shape of the elongated conduit can include from about 20 periods to about 500 periods or more. In a more detailed embodiment, the elongated conduit can include from about 20 periods to about 100 periods. Such parameters can be designed based on the particular plant configuration, oil sand properties, and operating conditions.

The conduit length, much like the other parameters of the conduit, can vary greatly according to the composition of the fluid, desired processing, pipe size and pipe composition. In a specific embodiment, the elongated conduit can have a length of greater than about ⅓ of a kilometer, as measured in a straight line from the initial part of the elongated conduit to the end part of the elongated conduit. In a further embodiment, the conduit can have a length of greater than about 30 meters, 100 meters, and even greater than about one kilometer.

Another factor to consider in creating or forming an elongated conduit is the material of the conduit. Standard pipe materials can be used in the present invention. Non-limiting examples include ceramic, metal and plastic. In a preferred embodiment, the elongated pipe includes a metallic material. In a more specific embodiment, the elongated pipe can comprise or consist essentially of steel. The diameter of the pipe can also vary as needs and other parameters of the elongated pipe are varied. In one embodiment, the elongated pipe can have an average diameter of about 20 centimeters to about 1 meter, although other diameters may be useful in specific applications. One factor to consider in selecting the diameter of the sinusoidal pipe is potential blockage of the pipe, which can result from the combination of pipe diameter, bend angles, and fluid to be processed. In the case of processing oil sands and water, the dimensions of rocks, oil sand lumps, and/or clay lumps can be less than 30% of the pipe diameter, in one aspect. In another aspect, the maximum dimension of the solids in the fluid can be less than 20% of the pipe diameter.

Oil sand can contain around 20% bitumen by volume. Consequently, the conduit cross-sectional area for processing bitumen froth or bitumen liquid will be smaller than used for processing oil sands. Although the average diameter above is noted to be of about 20 cm to about 1 meter in one embodiment, it is recognized that the appropriate diameter would be dependent on the fluid to be processed, the desired equipment and materials available, and the desired product. Furthermore, smaller pipes, tubes or hoses, e.g. having smaller diameter, would be used for scale-up and in laboratory designs. Such scaled sinusoidal pipes are expressly contemplated by the present invention. A non-limiting example of a conduit diameter that could be used on a smaller scale is about 2 cm. Hoses may also be used for large commercial applications. One advantage of hose is that it can readily be formed or forced into a sinusoidal shape and be replaced when it is worn out.

Processing various fluids can alter the physical properties of the fluid down the length of the pipe. As such, it can be useful to have at least one inlet and/or at least one outlet in fluid communication with an interior of the elongated pipe and remote from either end of the elongated pipe. The elongated pipes of the present invention have an inlet and an outlet. The inlet is at one end of the elongated pipe and is the primary source of introducing the fluid into the pipe. The outlet of the pipe is located at the opposite end of the pipe from the inlet and allows for removal of the processed fluid. In the additional embodiment, having at least one inlet in fluid communication with an interior of the elongated pipe and remote from either end of the elongated pipe, the pipe thus includes at least two inlets or outlets. Outlets can be used to remove, e.g., air or other gaseous portions of the incoming fluid. This is particularly useful when processing bitumen froth. Additional inlets can be used to introduce heated or cooled fluids, as well as washing agents and/or emulsion breaking chemicals. For example, soap and soft water can be added as a washing agent nearer the fluid inlet of the sinusoidal pipe, and gypsum can be added downstream of the soap and soft water addition to assist in breaking any emulsions formed by the soap. The inlet remote from either end of the elongated pipe can be used to introduce diluting materials, such as water, can introduce heated or cooled material to alter the temperature of the fluid in the pipe, or can be used to introduce additional fluid for processing into the pipe. Further, the additional inlet(s) can be used to introduce chemical agents that can be used to process a fluid through at least one chemical reaction. Some fluid processing may be improved or facilitated by controlling the temperature in the pipe, such as heating or cooling. In such cases, the elongated pipe can include a means for thermally controlling heat transfer into or out of the elongated pipe. In a specific embodiment, the means for thermally controlling can be an insulating material at least partially covering the elongated pipe. Other means for thermally controlling can include electrical resistive heating elements which can be placed near or in contact with the pipe and heat exchangers which can either cool or heat the pipe.

The fluid to be processed may contain unwanted solids. In such cases, the apparatus can include a crusher, screen or filter operatively associated with an inlet. The crusher can be configured to reduce the size of particulates before entering the pipe. The filter can be configured to filter fluid entering the pipe. Such filter can be attached or in near proximity to the pipe inlet. In another aspect, the filter can precede the inlet in processing. In one example, the screen can be a part of crushing equipment, used to create particulate solids for inclusion in the fluid.

Depending on the use of the conduit and the fluids being processed, it may be useful to have the elongated sinusoidal conduit connected to a length of pipe that is not configured as a repeating sinusoidal wave. Apart from processing fluid by mixing and/or shearing, the sinusoidal conduit can serve to transport material from one point to another. In some cases, it can be useful to limit the amount of processing to the fluid, yet may be necessary to transport the fluid. In such cases, a length of pipe, not configured as a sinusoidal wave, can be attached. Such attachment can be upstream, i.e. attached on the inlet side, of the sinusoidal conduit, or can be downstream, i.e. attached on the outlet side, of the sinusoidal conduit. In a specific embodiment, the length of pipe not configured as a repeating sinusoidal wave can be substantially straight. Further, multiple sections of sinusoidal conduit can be separated by straight sections of pipe or other equipment.

The sinusoidal conduit can be used to process a fluid such as mixing, shearing, or mixing and shearing a fluid which can include injecting the fluid at a high velocity into an end of a length of baffleless conduit configured as a repeating sinusoidal wave in a two-dimensional plane sufficient to restrict a line of sight down the length of the conduit.

Referring once again to FIG. 1, it can be seen that when fluid is injected into the pipe 2a at a high velocity, e.g. from the pump 4a, the fluid can travel with a velocity component that repeatedly alters directions. Such fluid path is noted with the dotted line 26, representing primarily a particulate portion of the fluid. In a specific embodiment of the present invention, the fluid travels with a velocity component that repeatedly alters positive and negative directions. Another way to describe this motion can be the fluid travels up and down and up and down, etc., along the length of the pipe. This is distinguished from flow in a corkscrew or helix-shaped pipe wherein the velocity component remains constant and does not experience distinctive directional velocity changes. The magnitude of the velocity can vary depending on the equipment used, the fluid composition, and the desired processing. In a specific embodiment, the magnitude of the velocity is from about 0.5 meters/second to about 5 meters per second.

The sinusoidal configuration of the elongated conduit, combined with injecting fluid into the conduit at a high velocity can induce bimodal vortex mixing in the conduit. The fluid flow depicted in FIG. 4 is a cross-sectional view of the elongated pipe of any of FIGS. 1, 2, and 3. FIG. 4 shows the particulate solids 40 at the lower portion of the pipe, and the dual vortexes 42. As shown, the fluid travels up the inner surface of the pipe and down a central portion of the pipe. Further, the particulate solids 26 tend to cross the bulk fluid periodically as illustrated in FIG. 1. Such mixing patterns can be extremely useful for mixing and shearing certain fluids, such as oil sands and water. In bimodal vortex mixing, the solid particulates travel through the pipe mixed in with the liquid and optional gaseous fluid. In one embodiment, where the fluid includes water, bitumen, clay, silt, sand, rocks (e.g. up to 33% of the pipe internal diameter), and/or similarly sized lumps of undigested oil sand, the inertia of the rocks and lumps causes them to be thrown to the outside of each bend or elbow in a delayed manner, and in the process, become thoroughly mixed with and sheared by the rest of the stream every time it passes through a bend or elbow. A secondary flow occurs in addition to the primarily sinusoidal flow as the fluid travels through the pipe, this secondary flow is identified as bimodal vortex. Such flow encourages solids to move to the outer curve of each elbow and causes additional mixing and shearing action on the lumps of oil sand. Mixing and shearing in accordance with the present invention results in the release of bitumen particles from the sand grains of the oil sand or in the release of air and/or the transfer of hydrophilic solids from the bitumen phase to the aqueous phase in the sinusoidal pipe. It will be understood that FIG. 4 is an idealized version of bimodal vortex flow and that actual flow will likely exhibit random fluctuations and chaotic mixing, especially under turbulent flow conditions. However, this idealized flow represents the bulk or average behavior of the fluid in accordance with some embodiments of the present invention.

Not all oil sand is the same, and the varying properties of the oil sand can be considered when designing a particular elongated conduit. Conditions and/or design of the sinusoidal conduit can be specifically configured for improved and optimum processing. In a specific embodiment, the repeating sinusoidal wave can be designed and shaped based on compositional and physical properties of the fluid. Therefore, parameters may be adjusted for varying types of oil sands. Further, in processing water and oil sand, the conduit combined with the high velocity of injecting the fluid can be configured to prevent bitumen emulsion formation. For example, pH of the fluid may be altered to reduce emulsion formation; a pH buffer and/or a de-emulsifier may be added. Many chemicals are available in the oil industry for breaking foams and emulsions.

Some oil sands contain a high percentage of bitumen and low percentage of fines, while other oil sands contain moderate or a small percentage of bitumen and further have a high fines content. Some oil sands come from a marine deposit and other oil sands come from a delta deposit, each having different characteristics. Some oil sands are chemically neutral by nature and other oil sands contain salts and other chemicals that affect, among other things, the pH. Temperature of the oil sands is another factor to consider. When the oil sands are frozen, they will require a greater amount of mixing, turbulence, and shear in the sinusoidal conduit to convert into a suitable slurry. The degree of crushing, and particle size of the oil sand is still another factor to consider. Similarly, the degree of screening or filtering that may optionally be done before the crushed oil sand is mixed with water and fed into the conduit can affect the optimum processing conditions. The amount and temperature of water used to create the fluid slurry with the oil sands are still other factors to consider.

Other factors to consider when dealing with oil sands include the composition of the rocks and gravel, and lumps of clay in the oil sand after crushing. Not only the size of the rocks, gravel and clay lumps but also the percentage of these in the crushed oil sand, as well as the shape of the rocks gravel or lumps of clay can affect processing conditions. Likewise, the chemical composition of the slurry as it is being processed by the serpentine pipeline can affect processing. For example, a fluid that has a low pH or a high pH inherently, or by the addition of chemicals will have a very different rheological characteristic than a slurry that is close to neutral or close to the isoelectric point. The pH of a fluid can have a substantial impact upon the dispersion of fines in such a fluid and upon the resulting viscosity of the fluid. At high or low pH the clay fines are dispersed, resulting in low viscosity fluids in which the coarse solids are very free to move within the fluid. Closer to the isoelectric point, which is closer to neutral pH, the fluid is much more viscous and this impacts on the behavior and on the circulation path of the coarse solids within the fluid as it moves through the sinusoidal conduit.

The temperature of the fluid as it flows through the sinusoidal conduit can effect processing. Bitumen viscosity varies greatly with temperature and, as bitumen is released from the oil sand grains of the slurry while traveling through the conduit, some of this bitumen may coalesce into zones of high bitumen concentration, resulting in a change in the rheology of the slurry as it flows through the serpentine conduit.

Any change in temperature as the fluid flows through the sinusoidal conduit can also affect processing. For example, when cold water is added at some point in the sinusoidal conduit, this cold water may significantly increase the bitumen viscosity. Alternately, when warm or hot water is added, this may also significantly decrease bitumen viscosity. An increase in bitumen viscosity may occur when the outside of the sinusoidal conduit is exposed to cold winter temperatures.

Certainly a factor to consider in selecting processing parameters is the velocity of the fluid as it flows through the sinusoidal conduit. For a given pump capacity, a different conduit size will result in a different slurry velocity in the conduit. Therefore, multiple pumps can be used in some embodiments along the sinusoidal conduit.

Additionally, the type of bend angle or elbow used in the construction of the serpentine conduit can affect processing. For example, for a given fluid velocity, a serpentine conduit made from 30 degree elbows will create less shear in the fluid than a serpentine conduit made from 90 degree elbows. In some cases, at high conduit velocities, the increased shear induced by sharper degree elbows may result in the production of some bitumen emulsion that may be hard to break quickly, especially when the chemistry of the slurry is favorable for the formation of bitumen slurries.

The length of straight sections between bends or elbows in the sinusoidal conduit or pipe is yet another factor that will affect processing. Long straight sections between bends or elbows may serve to minimize emulsification of certain mixtures being processed in the sinusoidal conduit by allowing such flowing mixtures a moment of relative quiescence between bends or elbows. Alternately, long straight sections between bends or elbows may allow for longer conduits and/or lower angle bends or elbows, and yet achieve the desired amount of mixing and shearing while retaining the desired restriction in the line of sight down the conduit. The number of bends or elbows and the angle of such bends or elbows in an elongated sinusoidal conduit can have a major impact on the amount of mixing and shearing to which a mixture is exposed but also on the amount of energy required to transport the mixture. Therefore responsible process design can tend to minimize the number and angle of bends or elbows to just achieve the desired mixing and shearing. This design would vary depending on the mixture being processed and be based on prior testing.

The roughness of the wall of the sinusoidal conduit is still another factor that can affect processing. For example, when part or all of the pipe inside is hard surfaced by welding, the welding tracks on the internal pipe surfaces will result in a significant increase in pipe wall roughness, which in turbulent flow, can create eddy currents which will have an impact on slurry flowing through the serpentine conduit.

As mentioned, the fluid can include particulate solids. Such particulate solids can, in some cases, be abrasive to the inner surface of the pipe. In a specific embodiment, the particulate solids entering the pipe can have an average particle size from about 0.2 centimeter to about 10 centimeters. In one embodiment, at least a portion of the particulate solids follow a serpentine path which periodically crosses a central volume of the fluid as it flows through the pipe. Such is the case illustrated in FIGS. 1 and 3.

Fluids that can be mixed and/or sheared according to the present method can include, in one detailed aspect, water and oil sand. The oil sand can, depending on the source, be frozen. In such cases, it may be beneficial to include a heating step to the method, and/or increasing the length of sinusoidal conduit for processing. Because of the configuration of the sinusoidal conduit, it can easily be located at or near the site of mining oil sand. Therefore, the method for mixing and/or shearing a fluid including oil sands can include forming a slurry from oil sands at the site of mining the oil sand from an oil sand deposit. Due to the unique structure of the processing equipment, the slurry can be injected into the conduit at or in the proximity of the mining. This is true for mining operations wherein the overburden has been removed, as well as in operations wherein the overburden has not been removed from the oil sand deposit.

The method for mixing and/or shearing a fluid including oil sands and water can cause removal of bitumen from sand grains of the oil sand. Processing oil sand and water can produce a slurry including a variety of components. Depending on processing time, conditions, and feed fluid, the components can include any combination of bitumen, gravel, sand, silt, clay, and water.

Rather than process oil sands directly, the sinusoidal conduit of the present invention can be used to process a bitumen froth product from an oil sands separation process using the Clark process or to process a liquid bitumen product from the Kruyer process. In such cases, the method of mixing and/or shearing can include transferring hydrophilic solids from a bitumen product to water by passing water and bitumen product through the elongated conduit. In this invention, continuous phase bitumen containing solids and water droplets are mixed with continuous phase water in the serpentine conduit to break up the continuous phase bitumen into bitumen droplets suspended in water. As part of this process, hydrophilic solids are released from the bitumen phase and enter the water phase. Additionally, air may be released from a froth product. When this mixture is subsequently separated the resulting bitumen product contains less hydrophilic solids than the bitumen entering the serpentine conduit.

Unlike in bitumen froth, in bitumen product from the Kruyer process the dispersed water droplets in the bitumen normally are at a pH close to neutral and the bitumen phase contains little or no air. For example, the bitumen product of the Kruyer process can have a pH of about 6.5 to about 7.5, whereas the bitumen froth of the Clark process can have a pH of about 8 to about 9. However, the high turbulence and high shear in the sinusoidal conduit may still emulsify the bitumen droplets in the water phase. As a result, pH control or additions of emulsion breaking chemicals may be beneficial. Subsequent to treatment with the serpentine conduit, the bitumen product and water phase can be separated by any suitable process or mechanism such as, but not limited to, an endless wrapped cable, an apertured oleophilic wall, a bitumen agglomerator, combinations of these, or the like.

Instead of or after processing a bitumen product with water to remove hydrophilic solids, the sinusoidal conduit or conduit of the instant invention may be used as part of a process to remove asphaltenes, water and solid particulates from a bitumen product by mixing and diluting the bitumen product with a hydrocarbon solvent such as propane, butane, pentane, heptane, hexane, octane or similar paraffinic hydrocarbon. After mixing in the serpentine conduit, the resulting diluted product stream may then be separated into a diluted bitumen product containing mostly solvent and maltenes by precipitating out a tailings product containing mostly water, solids and asphaltenes. This precipitating out or separating may be done warm by settling in vessels, by means of hydrocyclones or with centrifuges. After such separation the solvent may be distilled at elevated temperature from the diluted bitumen product and the resulting predominantly maltenes pipelined to a refinery and/or upgraded to synthetic crude oil whilst the tailings, consisting mainly of asphaltenes, water and solids are discarded or processed further.

In the case of processing oil sands and/or bitumen product, additives can be added to the fluid prior to introduction into the conduit. Alternatively, additives to assist in the processing can be added via inlets to the conduit that are remote from either end of the sinusoidal conduit. One additive that can be useful in oil sands and bitumen is a washing additive. Non-limiting examples of washing additives can include soaps, detergents, and water softeners.

Fluids treated by the present method can, in some aspects, benefit from additional treatment and/or modified processing conditions. In one embodiment, the method can include screening or filtering the fluid prior to injecting the fluid into the conduit. In another aspect, the fluid can be heated. Such heating can occur prior to injecting the fluid into the conduit. Alternatively, or additionally, the method can include heating the fluid while in the conduit. A non-limiting example of heating the fluid while in the conduit can include injecting heated fluid into the conduit. Injecting heated fluid can occur at the initial part of the conduit, and/or in a plurality of locations on the conduit. In a specific embodiment, heated fluid can be injected into the conduit at a central location. Heated fluid injected at locations other than a primary inlet, i.e. the fluid injected into the inlet at one end of the conduit can be either the same fluid as the processing fluid or a different and diluting fluid, e.g. water.

Processing time for fluids differs greatly depending on the pipe, fluid, desired processing, etc. As a non-limiting example, however, the fluid can have an average residence time in the elongated conduit configured as a repeating sinusoidal wave of from about half a minute to about fifteen minutes.

While the sinusoidal conduit may have other applications as a mixer, its can work well to digest oil sands with water to create a slurry for subsequent separation processes, e.g., by a hydrocyclone and/or an oleophilic endless cable, which processes are disclosed in the related co-pending patent applications identified above. Alternatively, the sinusoidal conduit can be used for cleaning up bitumen product from an oil sand separation process (in particular, bitumen product from an endless cable belt processing, and other oil sand separation processes). In such cases, water can be added to the bitumen product to wash hydrophilic solids from this bitumen in the elongated conduit or a paraffinic hydrocarbon to further clean the bitumen product.

Therefore, as outlined above, the instant invention can function to mix and/or shear fluids. In a specific use, the instant invention can eliminate the need for huge conditioning drums to disengage bitumen from mined oil sand grains, can eliminate cyclo feeders and long pipelines to disengage bitumen from mined oil sand grains, and/or can eliminate jet pumps and long pipelines to disengage bitumen from mined oil sands and may be used to reduce the cost of subsequent bitumen processing or clean up. The present invention can effectively process, at least partially, oil sands and bitumen in a manner that does not require hazardous substances, and does not produce hazardous, toxic, or dangerous by-product streams. The method can be performed at cooler temperatures, with less time, and with equipment that is less cumbersome than previous methods.

Of course, it is to be understood that the above-described arrangements, and specific examples and uses, are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A system for mixing and/or shearing a fluid, comprising:
a) an elongated conduit having an inlet and an outlet, said elongated conduit being configured as a repeating sinusoidal wave in a two-dimensional plane sufficient to restrict a line of sight down the length of the conduit; and
b) a pump operatively associated with the elongated conduit and configured to force fluid through the elongated conduit.

2. The system of claim 1, wherein the elongated conduit comprises a plurality of pipe sections, wherein at least one pipe section is an elbow having a bend angle between 22 and 91 degrees.

3. The system of claim 2, wherein the plurality of pipe sections include a plurality of substantially straight pipe sections connected by a plurality of elbows each having a substantially identical bend angle in an alternating sequence of pipe and elbow.

4. The system of claim 1, wherein the elongated conduit is formed from one or more reinforced rubber, urethane or plastic hoses.

5. The system of claim 1, wherein the elongated conduit is an elongated pipe and at least a portion of an inner surface of the elongated pipe is hard surfaced to serve as a wearing surface or is lined with plastic, rubber, epoxy, or combinations thereof.

6. The system of claim 1, wherein the repeating sinusoidal wave includes from about 20 periods to about 500 periods.

7. The system of claim 1, wherein the elongated conduit has a length greater than 100 meters.

8. The system of claim 1, further comprising one or more auxiliary inlets and/or outlets in fluid communication with an interior of the elongated conduit and remote from either end of the elongated conduit.

9. The system of claim 1, wherein the repeating sinusoidal wave of the elongated conduit has an amplitude and a period such that a ratio of the amplitude to the period is from about 1:5 to about 5:1.

10. A method for mixing and/or shearing a fluid containing particulate solids, comprising:
injecting the fluid at a high velocity into an end of a length of baffleless conduit configured as a repeating sinusoidal wave in a two-dimensional plane sufficient to restrict a line of sight down the length of the conduit.

11. The method of claim 10, wherein the fluid travels with a velocity component that repeatedly alters positive and negative directions.

12. The method of claim 11, wherein the velocity has a magnitude from about 0.5 to about 5 meters per second.

13. The method of claim 11, wherein the serpentine sinusoidal wave is designed and shaped based on compositional and physical properties of the fluid.

14. The method of claim 11, wherein at least a portion of the particulate solids follow a serpentine path which periodically crosses a central volume of the fluid as it flows through the conduit.

15. The method of claim 11, wherein the fluid includes water and oil sand, wherein the high velocity and the repeating sinusoidal wave are sufficient to cause removal of bitumen from sand grains of the oil sand.

16. The method of claim 15, wherein the high velocity of injecting the fluid and the conduit configured as a repeating sinusoidal wave are configured to prevent bitumen emulsion formation.

17. The method of claim 15, further comprising recovering a mechanically separable slurry product comprising bitumen, gravel, sand, silt, clay, and water for subsequent mechanical separation.

18. The method of claim 15, wherein the fluid includes water and a bitumen product from an oil sands separation process and wherein hydrophilic solids from said bitumen product transfer to said water by passing said water and said bitumen product through the elongated conduit.

19. The method of claim 15, wherein the fluid includes entrained air.

20. The method of claim 15, wherein the fluid has a pH about 6.5 to about 7.5.

21. The method of claim 15, further comprising forming a fluid slurry from oil sands from an oil sand deposit from which overburden has not been removed.

22. The method of claim 15, further comprising forming a fluid slurry from oil sands from an oil sand deposit from which overburden has been removed.

23. The method of claim 15, wherein the fluid includes warm or hot water

24. The method of claim 10, wherein an average residence time of the fluid in the elongated conduit configured as a repeating sinusoidal wave is from about half a minute to about fifteen minutes.

25. The method of claim 10, wherein the fluid includes a bitumen product containing water and particulate solids and includes a hydrocarbon solvent comprising propane, butane, pentane, hexane, heptane, or octane and/or mixtures thereof for the purpose of transferring maltenes from the bitumen product to the hydrocarbon solvent and to precipitate asphaltenes, water and solids therefrom in a subsequent separation step.
